(19) United States
(12) Patent Application Publication
(10) Pub. No.: US 2013/0009891 A1
(43) Pub. Date: Jan. 10, 2013

(54) IMAGE PROCESSING APPARATUS AND CONTROL METHOD THEREOF

(75) Inventors: Kazuhiro Watanabe, Tokyo (JP); Wataru Kaku, Yokohama-shi (JP); Daijirou Nagasaki, Kamakura-shi (JP); Nobuo Oshimoto, Kawasaki-shi (JP); Susumu Oya, Kamakura-shi (JP); Yusuke Hokari, Tokyo (JP); Eri Kanai, Kawasaki-shi (JP)

(73) Assignee: CANON KABUSHIKI KAISHA, Tokyo (JP)

(21) Appl. No.: 13/538,055

(22) Filed: Jun. 29, 2012

(30) Foreign Application Priority Data
Jul. 4, 2011 (JP) 2011-148284

(51) Int. Cl. G06F 3/041

(52) U.S. Cl. 345/173

(57) ABSTRACT

Display means capable of displaying a plurality of objects, detection means for detecting a body, specifying means for specifying a first object displayed in the display means by a movement of the body, measurement means for measuring a distance between the body and the display means, and display control means for determining whether the first object or a second object which is different from the first object is displayed on a front side in the display means in accordance with the distance are provided.

### BACKGROUND OF THE INVENTION

1. Field of the Invention

The present invention relates to a user interface technique.

2. Description of the Related Art

In recent years, display panels which change display in panels in response to detection of a user's finger, an input pen, or the like which approaches panel surfaces have been used.

Japanese Patent Laid-Open No. 2009-183592 discloses a method for specifying, when a user moves close to a panel surface which displays a plurality of button images, one of the button images to which the user comes close and enlarging, when the user does not move close to a certain region corresponding to the specified button image, the button display so as to prompt the user to perform an operation.

Furthermore, Japanese Patent Laid-Open No. 10-269022 discloses a method for enlarging, when a user's finger or the like moves close to a display device, an image in the vicinity of a coordinate to which the user's finger comes close.

Furthermore, Japanese Patent Laid-Open No. 2009-80702 discloses a method for displaying cursor image data larger in a flat table surface as a receptor which is held by a user's hand moves away from the flat table surface.

In any of the disclosures, a display method taking overlapping of a plurality of objects displayed in a panel into consideration is not disclosed. Therefore, a plurality of objects displayed in a panel are not comfortably operated.

### SUMMARY OF THE INVENTION

An object of the present invention is to allow a user to comfortably control a plurality of objects in a panel by changing display taking overlapping of the objects into consideration in accordance with a distance between a panel surface and an instruction body (such as a user's finger).

According to an aspect of the present invention, display means capable of displaying a plurality of objects, detection means for detecting a body, specifying means for specifying a first object displayed in the display means by a movement of the body, measurement means for measuring a distance between the body and the display means, and display control means for determining whether the first object or a second object which is different from the first object is displayed on a front side in the display means in accordance with the distance are provided. Accordingly, the user can comfortably control the display means which displays the plurality of objects.

Further features of the present invention will become apparent from the following description of exemplary embodiments with reference to the attached drawings.

### BRIEF DESCRIPTION OF THE DRAWINGS

FIG. 1 is a block diagram illustrating a configuration of a display control apparatus;

FIG. 2 is a flowchart illustrating a process performed by the display control apparatus;

FIG. 3 is a table of examples of display;

FIG. 4 includes diagrams illustrating transition of a screen of a photo viewer displayed in accordance with a user's operation;

FIG. 5 includes diagrams illustrating transition of the screen of the photo viewer displayed in accordance with a user's operation;

FIG. 6 includes perspective views of FIG. 4;

FIG. 7 is a perspective view of FIG. 5;

FIG. 8 includes diagrams illustrating transition of a screen of an image editing apparatus displayed in accordance with a user's operation;

FIG. 9 includes diagrams illustrating transition of the screen of the image editing apparatus displayed in accordance with a user's operation;

FIG. 10 includes diagrams illustrating transition of the screen of the image editing apparatus displayed in accordance with a user's operation;

FIG. 11 includes diagrams illustrating transition of the screen of the image editing apparatus displayed in accordance with a user's operation;

FIG. 12 is a diagram illustrating transition of the screen of the image editing apparatus in accordance with a user's operation;

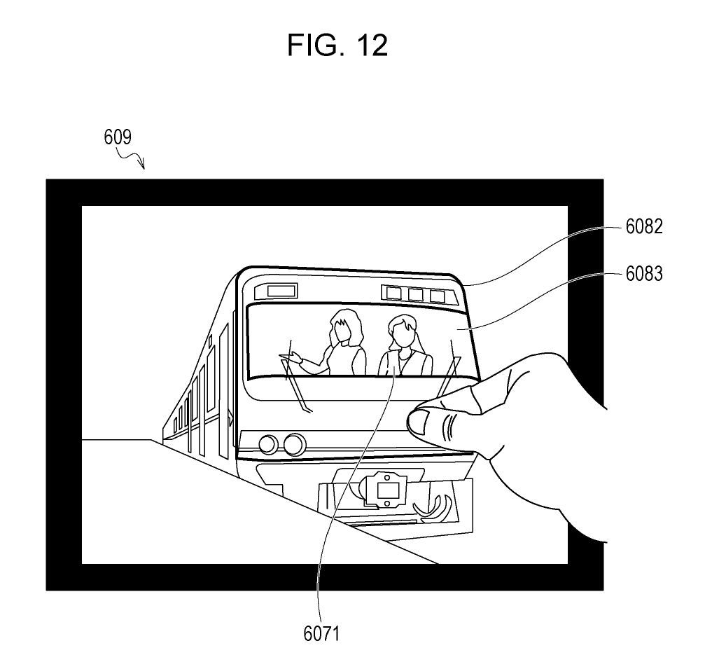

FIG. 13 includes diagrams illustrating transition of a screen of a layer file management device displayed in accordance with a user's operation;

FIG. 14 includes diagrams illustrating transition of a screen of a geographical file management device displayed in accordance with a user's operation;

FIG. 15 includes diagrams illustrating transition of the screen of the geographical file management device displayed in accordance with a user's operation;

FIG. 16 is a block diagram illustrating a configuration of a display control apparatus; and

FIG. 17 is a flowchart illustrating a process performed by the display control apparatus.

### DESCRIPTION OF THE EMBODIMENTS

Hereinafter, preferred embodiments of the present invention will be described in detail with reference to the accompanying drawings. Note that configurations in the embodiments below are merely examples and the present invention is not limited to the illustrated configurations.

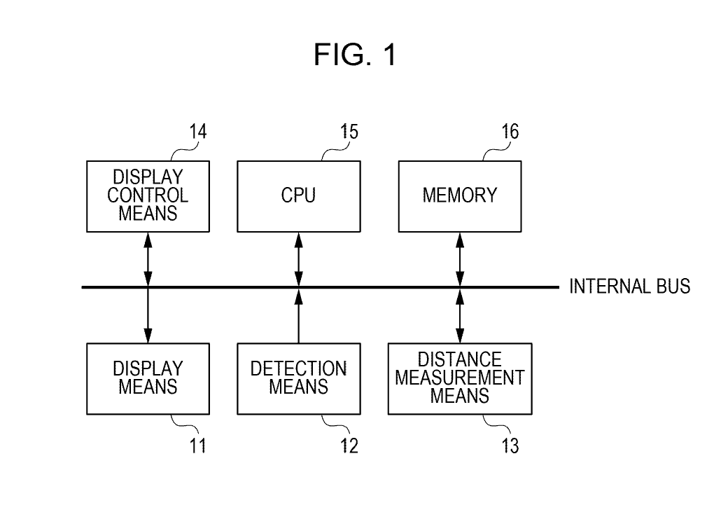

FIG. 1 is a diagram illustrating a configuration of a display control apparatus according to a first embodiment. In FIG. 1, the display control apparatus includes display means 11, multi-touch panel means 12, distance measurement means 13, display control means 14, a CPU 15, and a memory 16.

The display means 11 displays a screen including a plurality of GUI objects in a panel. The detection means 12 detects a user's operation and selects one of the plurality of objects displayed in the panel which is specified by a user. Here, when the user touches a certain object, the touched object is specified. Hereinafter, the object specified by the detection means 12 is referred to as a “specific object”. Note that an object is specified not only by a touch operation but also by other methods. For example, a method for specifying an object by moving a user's finger close to the object within a predetermined distance or a method for specifying an object when the user stops for a predetermined period of time near a panel may be employed.

The distance measurement means 13 measures a distance between a panel surface of the display means 11 and a body. Here, the body corresponds to a user's finger. Note that an instruction pen or the like may be used. General methods may be used as a method for measuring a distance between the panel surface and the body. As the method for measuring a distance between the panel surface and the body, a method utilizing change of an electrostatic capacitance, a method utilizing reflection of an ultrasonic wave or an acoustic wave, a method utilizing the principle of triangulation in image pickup means (not shown) included in the display means 11, or the like may be employed. Here, the method utilizing change of an electrostatic capacitance is employed in the distance measurement means 13. The distance measurement means 13 includes an electroconductive film closely attached to the panel surface and an electrostatic capacitance meter. The distance measurement means 13 measures an electrostatic capacitance of a circuit formed by the body, the electroconductive film, the electrostatic capacitance meter, and a surrounding environment including the ground using the electrostatic capacitance meter. By this, a distance between the panel surface to which the electroconductive film is closely attached and the body is calculated.

The display control means 14 controls display of the objects in the display means in accordance with a distance between the body and the panel surface measured by the distance measurement means 13. The display control means 14 changes display of the display means 11 taking overlapping of the specific object and the other objects into consideration. Specifically, when a finger moves away from the panel screen, display is changed so that the specific object seems to be in front of the other objects. The specific object is enlarged, a shadow of the specific object is displayed on the other objects, and the other objects such as a background are faded. On the other hand, when a user's finger moves close to the panel surface, the display control means 14 changes display so that the specific object is displayed on a back side of the other objects. In this case, a size of the specific object is reduced, an area of the shadow of the specific object displayed on the other objects is reduced, or blur amounts of the other objects such as the background is reduced. By this, the user can operate a plurality of objects displayed in the display means by a simple operation.

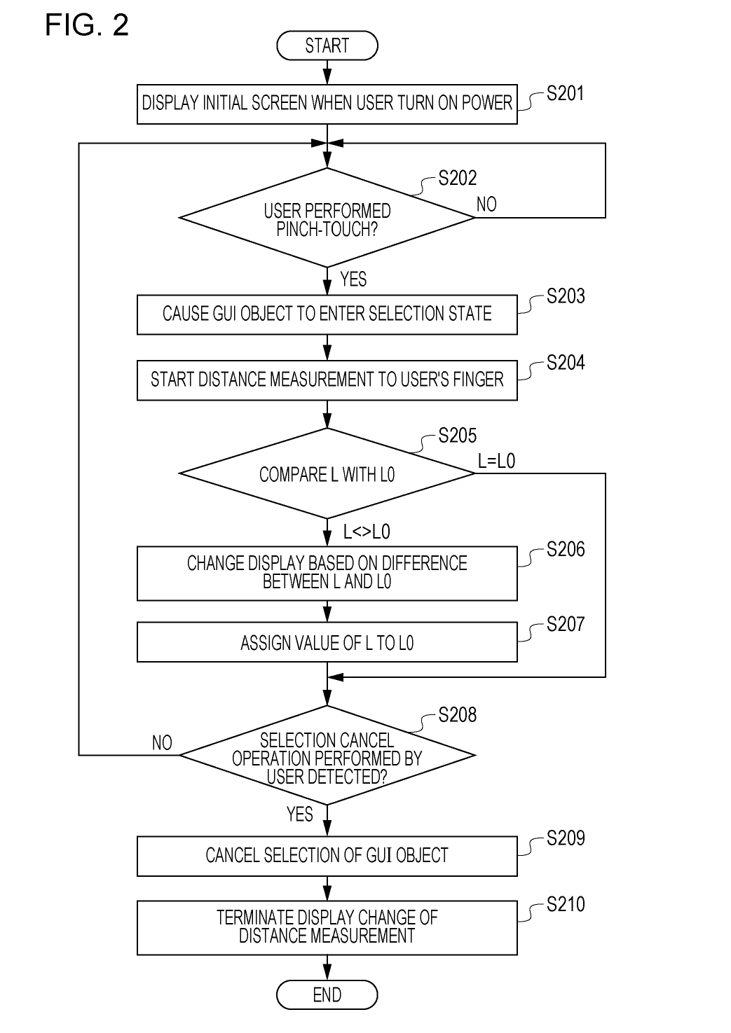

FIG. 2 is a flowchart illustrating a display control process according to the first embodiment. In step S201, when the user turns on the display control apparatus, an initial screen is displayed. In step S202, the detection means 12 detects a touch on the display means 11 performed by the user. In step S203, the detection means 12 displays one of the objects displayed in the display means 11 which is touched in a selection state.

Subsequently, in step S204, the distance measurement means 13 starts measurement of a distance from the panel surface to the user's finger. The distance measurement means 13 outputs information on the measured distance between the panel surface and the user's finger to the display control means 14. In step S205, the display control means 14 compares a distance L between the panel surface and the user's finger received from the distance measurement means 13 with a distance L0 which has been measured before. When the distances L and L0 are different from each other, control is performed in step S206 whereas when the distances L and L0 are the same as each other, the process proceeds to step S208.

In step S206, the display control means 14 performs display change in accordance with the difference between the distances L and L0. This operation will be described in detail hereinafter. After the display change is performed, the distance L0 is updated by the distance L. In step S208, it is determined whether a predetermined selection cancel operation has been performed such as an operation in which the user's finger which has been located close to the panel surface moves out of a measurement available range. When it is determined that the selection cancel operation has been performed, the object displayed in the selection state is changed to be a non-selection state in step S209.

In step S210, the distance measurement means 13 terminates the measurement of the distance between the panel surface and the finger and the display control means 14 terminates the display change performed in accordance with the distance. The display control process of this embodiment is terminated as described above.

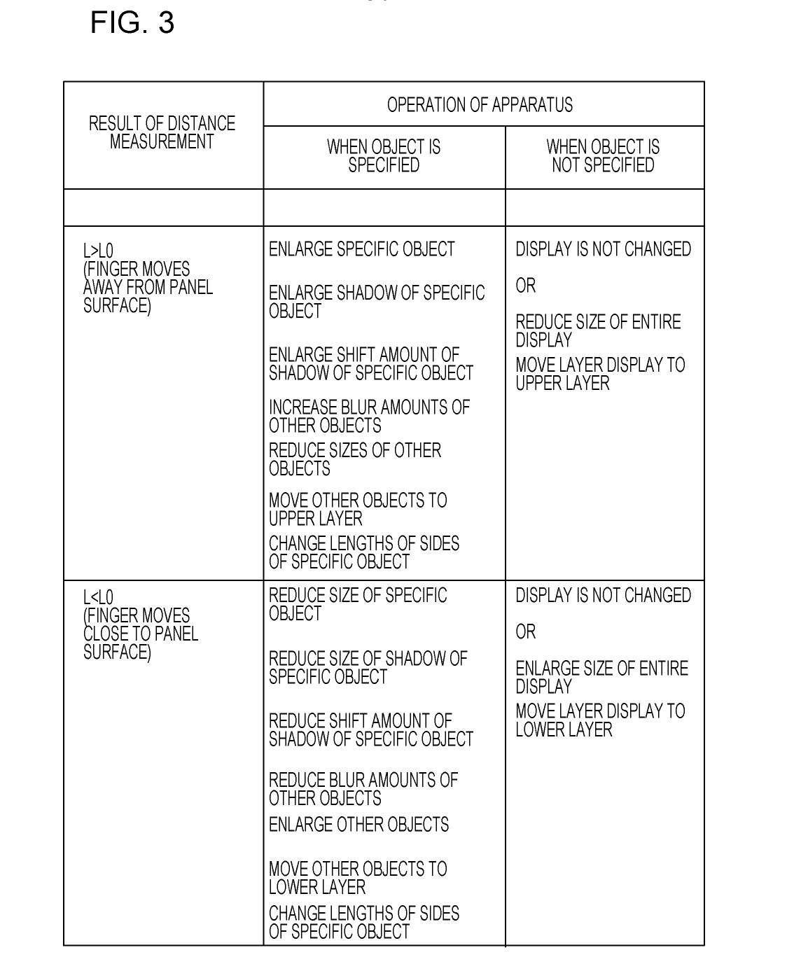

FIG. 3 is a diagram illustrating display performed in accordance with the distance between the panel surface and the user's finger. When the distance L is larger than the distance L0, the display is controlled such that an overlapping state of the specific object and the other object is changed. Alternatively, the display is controlled such that the specific object is displayed so as to seem to be in front of the other objects. For example, the specific object is enlarged, the shadow of the specific object displayed on the other objects is enlarged, and the sizes of the other objects are reduced.

On the other hand, when the distance L is smaller than the distance L0, the display is controlled such that the overlapping state of the specific object and the other object is changed. Alternatively, the display is controlled such that the specific object seems to be displayed on the back side of the other objects. Specifically, the display is changed such that the other objects seem to be displayed in front of the specific object. For example, the size of the specific object is reduced and the other objects are enlarged.

The display control relates to perspective of the objects seen by the user when the user pinches a physically-existing object and moves the object closer to the user or away from the user. As described above, since the overlapping state of the objects is displayed in accordance with the actual perspective, the user can select an object to be specified from among the plurality of objects with a simple operation. Furthermore, since the specific object seems to be displayed in front of the other objects or on the back side of the other objects in accordance with the distance between the finger and the panel, a desired operation can be easily performed on the specific object.

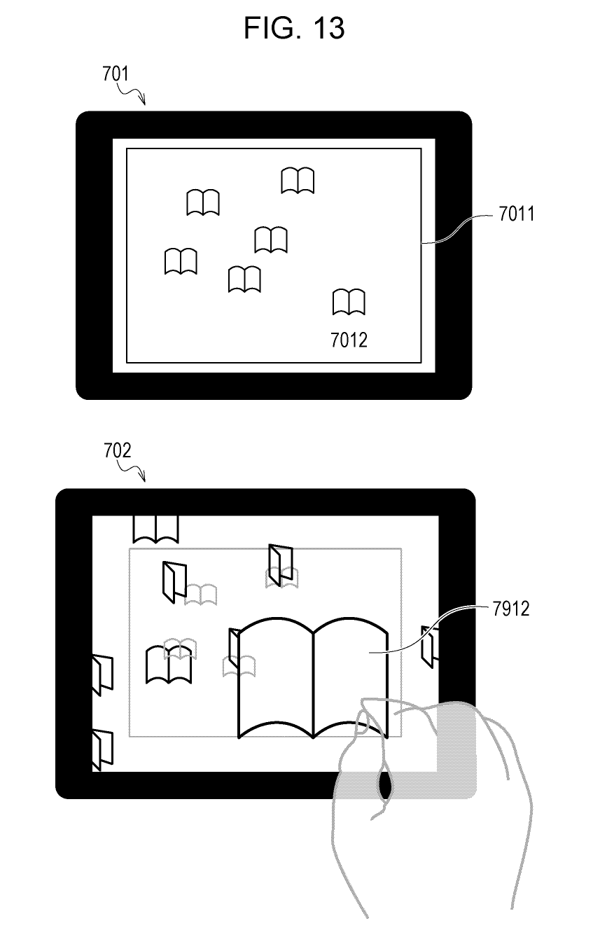

FIG. 13 is a diagram illustrating transition of display in the screen in accordance with an operation performed by a user's finger when the display control apparatus according to this embodiment is used in a layer file management apparatus. The layer file management apparatus performs display such that computer data managed for each file is specified and operated by the user with reference to a file management layer of interest. In general, the layer file management apparatus includes GUI display means and pointing means and displays a GUI object representing a file as well as a GUI representing a layer. The layer file management apparatus of this embodiment further includes multi-touch panel means serving as the pointing means, image pickup means, and finger-distance measurement means.

A screen 701 represents an initial state of the layer file management apparatus (in a state in which immediately after power is on or the like). In the initial state, a frame 7011 representing a certain data layer and a plurality of thumbnails representing files of the layer are displayed. Among the plurality of thumbnails displayed in the screen by the user, a thumbnail 7012 is touched in a pinch manner. Here, the term “pinch” means a state in which a thumb and at least one of the other fingers of the user move close to each other. By this pinch-touch, the thumbnail 7012 is selected as a specific object.

When the user's finger which has performed the pinch-touch moves away from the panel surface (so that the user's finger is pulled toward the user), the screen 701 changes to a screen 702. In the screen 702, the specific thumbnail 7012 is displayed in an enlarged manner and a shadow of the thumbnail 702 is displayed on the other objects (including the background and thumbnails other than the thumbnail 7012). Furthermore, the sizes of the other objects (including the frame 7011 and the thumbnails other than the thumbnail 7012) are reduced and display color density of the other objects is lowered, and the blur amounts are increased in the display. Furthermore, thumbnails of files and folders in a layer higher than the layer of the frame 7011 are displayed using an overlapping (translucent) display effect.

This represents a fact that the file represented by the thumbnail 7012 is moved to an upper layer from the original layer by a pinch-and-pull operation performed by the user. As described above, the user can change a file management layer with a visual sensation of a “pinching operation” performed on a GUI object, and therefore, the user can instinctively perform a data management operation.

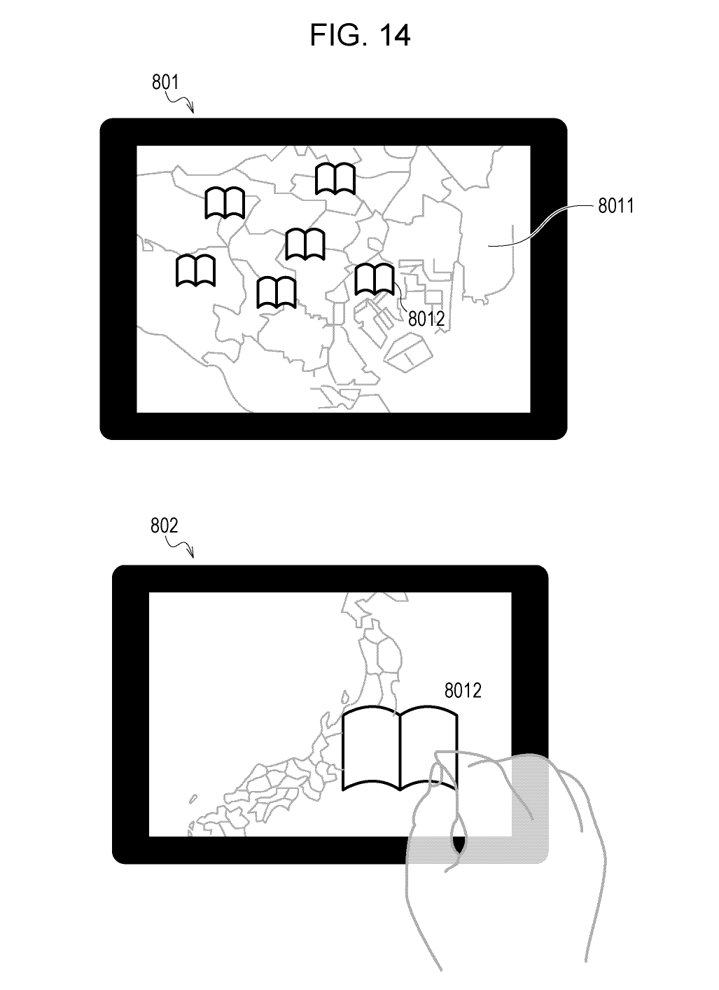

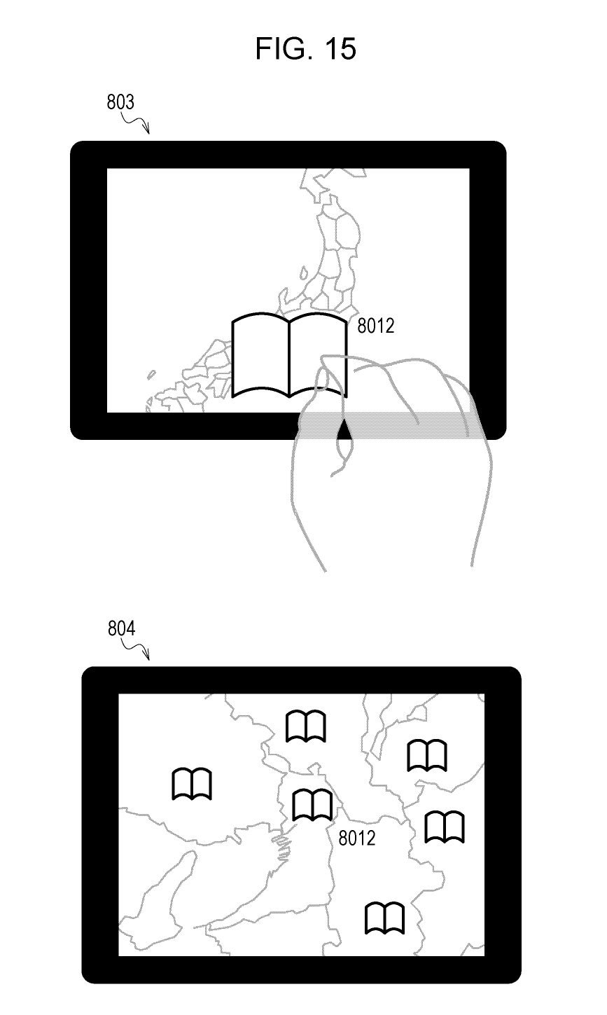

FIGS. 14 and 15 include diagrams illustrating a case where the display control apparatus according to this embodiment is employed in a geographical file management apparatus. The geographical file management apparatus displays computer data which is managed on a file-by-file basis so that the user can perform an instruction and an operation while comparing the computer data with a management position of a file of interest. In general, the geographical file management apparatus includes GUI display means and pointing means and displays a GUI object representing a file along with a GUI (map) representing a geographical position. The geographical file management apparatus of this embodiment further includes multi-touch panel means serving as the pointing means, image pickup means, and finger distance measurement means.

A screen 801 represents an initial state of the geographic file management apparatus (in a state immediately after power is on or the like). In the initial state, a bitmap 8011 representing a certain data map and thumbnails representing files in the map are displayed. When the user performs pinch-touch on a thumbnail 8012 in the screen, the thumbnail 8012 is selected as a specific object.

When the user's finger which has performed the pinch-touch moves away from the panel surface (so that the user's finger is pulled toward the user), the screen 801 changes to a screen 802. In the screen 802, the specific thumbnail 8022 is displayed in an enlarged manner and a shadow of the thumbnail 8022 is displayed on other objects (including a background). Furthermore, a scale size of the map displayed in the screen 801 is enlarged (so that a larger region can be displayed), thumbnails other than the thumbnail 8012 are displayed small, and blur amounts thereof are increased in the display. With this display, the user recognizes that the specific object is located on a front side.

When the user's finger moves while maintaining a distance to the panel surface which is substantially the same as the state of the screen 802, the screen 802 changes to a screen 803. In the screen 803, the display of the map shown in the screen 802 is maintained and the thumbnail 8012 is moved along with the movement of the finger.

When the finger is moved toward the panel surface by the user in a pinch state, the screen 803 is changed to a screen 804. The scale size of the map displayed in the screen 803 is reduced with a position of the user's finger as a center, the thumbnails other then the specific thumbnail 8012 are enlarged, and the blur amounts thereof are reduced in the display. Furthermore, the size of the specific thumbnail 8012 is reduced and the shadow of the thumbnail 8012 which has been displayed on the other objects is not displayed.

As described above, the specific object and the other objects are displayed taking an overlapping state of the specific object and the other objects into consideration in accordance with the distance between the user's finger and the panel surface. The user can move and change a geographical position associated with the file represented by the specific thumbnail 8012 with a simple operation such as the pinch-and-pull operation while a map of a wide region is displayed. The user can change a geographical position associated with a file with a visual sensation of a “pinching operation” performed on a GUI object, and therefore, the user can instinctively perform a data management operation.

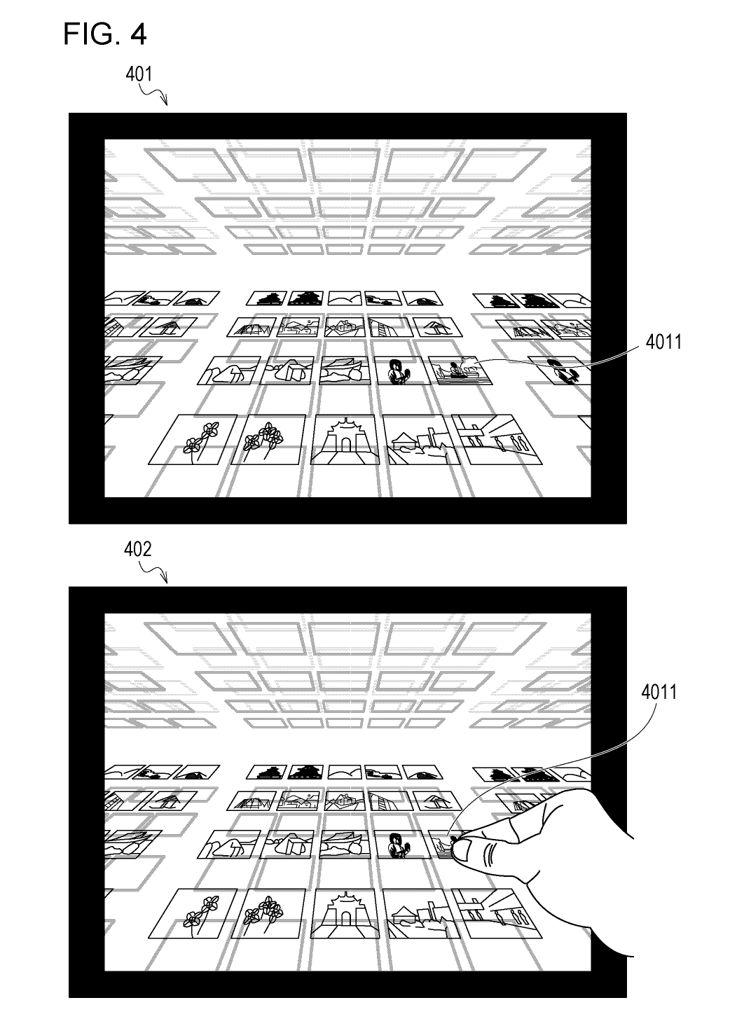

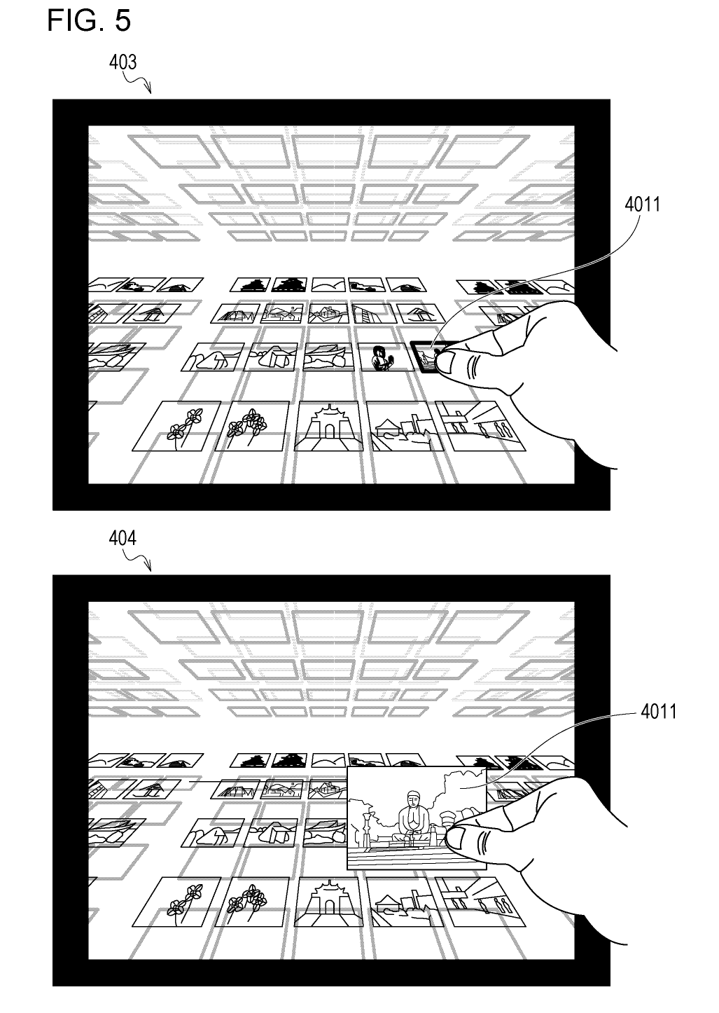

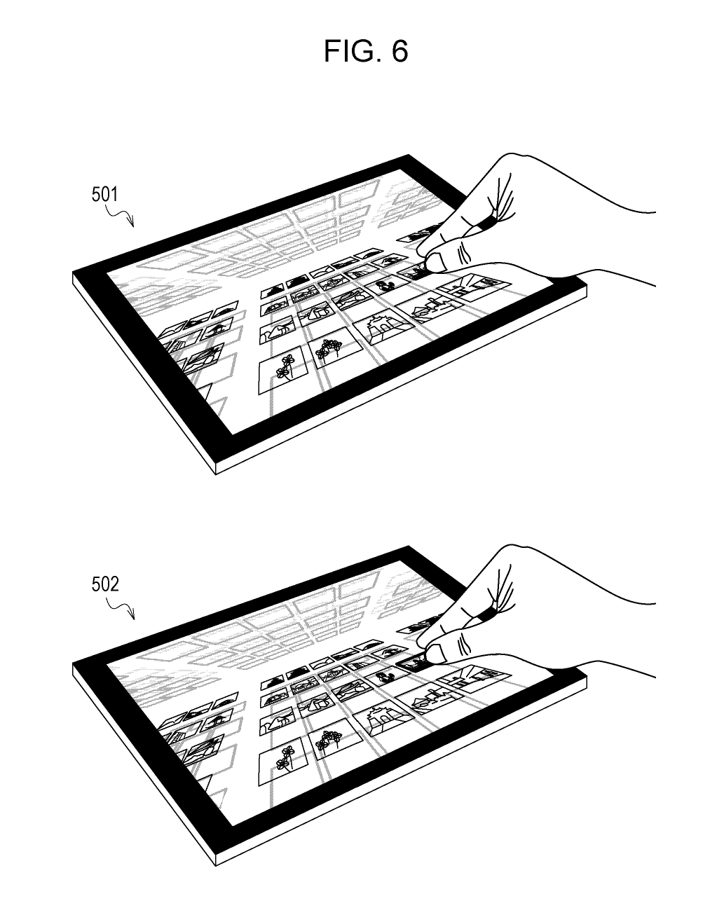

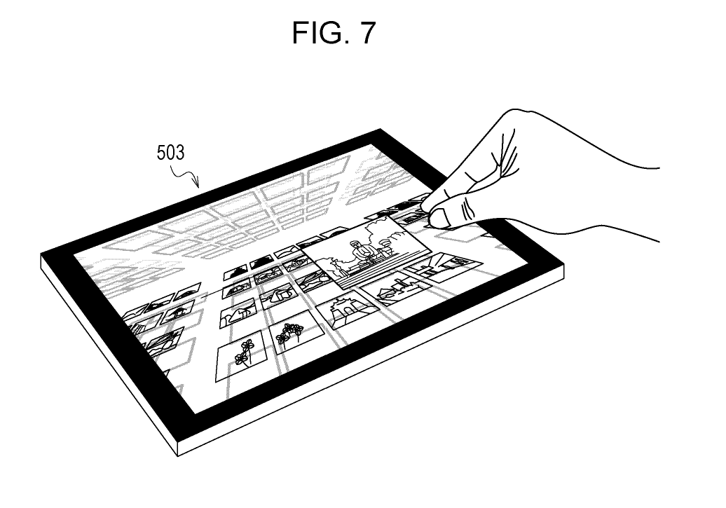

FIGS. 4 and 5 include diagrams illustrating a case where the display control apparatus according to this embodiment is employed in a photo viewer. Furthermore, screens 501 and 502 illustrated in FIG. 6 and a screen 503 illustrated in FIG. 7 are perspective views corresponding to screens 402 and 403 illustrated in FIG. 4 and a screen 404 illustrated in FIG. 5. The photo viewer generally includes a display screen such as a liquid crystal display, display control means, and a storage device such as a hard disk. The photo viewer stores image files (coded data compressed by JPEG or the like) captured and generated by a digital still camera or the like and displays slide show or the like of the image files on the display screen in accordance with a user's instruction. The photo viewer illustrated in FIGS. 4 and 5 further includes a finger distance measurement means and touch panel means.

The screen 401 represents an initial state of the photo viewer (in a state immediately after power is on or the like). In the screen 402, the user performs pinch-touch on a thumbnail 4011 in the screen. The multi-touch panel means recognizes a position where the user touched and selects the thumbnail 4011 located at the position as a specific object. In the screen 403, the display control means performs display control such that the thumbnail 4011 is edged so as to represent that the thumbnail 4011 is specified.

When the user's finger moves away from the panel surface (so that the user's finger is pulled toward the user), the screen 403 changes to the screen 404. The display control means enlarges the specific thumbnail 4011 and changes lengths of sides of the thumbnail 4011 in order to change an overlapping display order so that the specific thumbnail 4011 is displayed on a font side relative to the user. Furthermore, a shadow of the thumbnail 4011 is formed on objects other than the thumbnail 4011.

Note that when the user's finger moves toward the screen (that is, moves away from the user), the display control means changes an overlapping state such that the specific thumbnail 4011 is displayed on a far side relative to the user. A size of the thumbnail 4011 is reduced and the lengths of the sides are changed. Furthermore, the shadow of the thumbnail 4011 is displayed on the other objects while a size of the shadow of the thumbnail 4011 is reduced. The display control relates to perspective of the objects seen by the user when the user pinches a physically-existing object and moves the object closer to the user or away from the user. Accordingly, with the display control performed as described above, the user can have a feeling that the user is operating a GUI object. When a method for operating a GUI is made close to a method for operating a physically existing object, the user is more likely to have predictability representing that “this operation leads this process performed by an apparatus”, and a burden of learning of operation methods is reduced. Therefore, operability is improved as a whole.

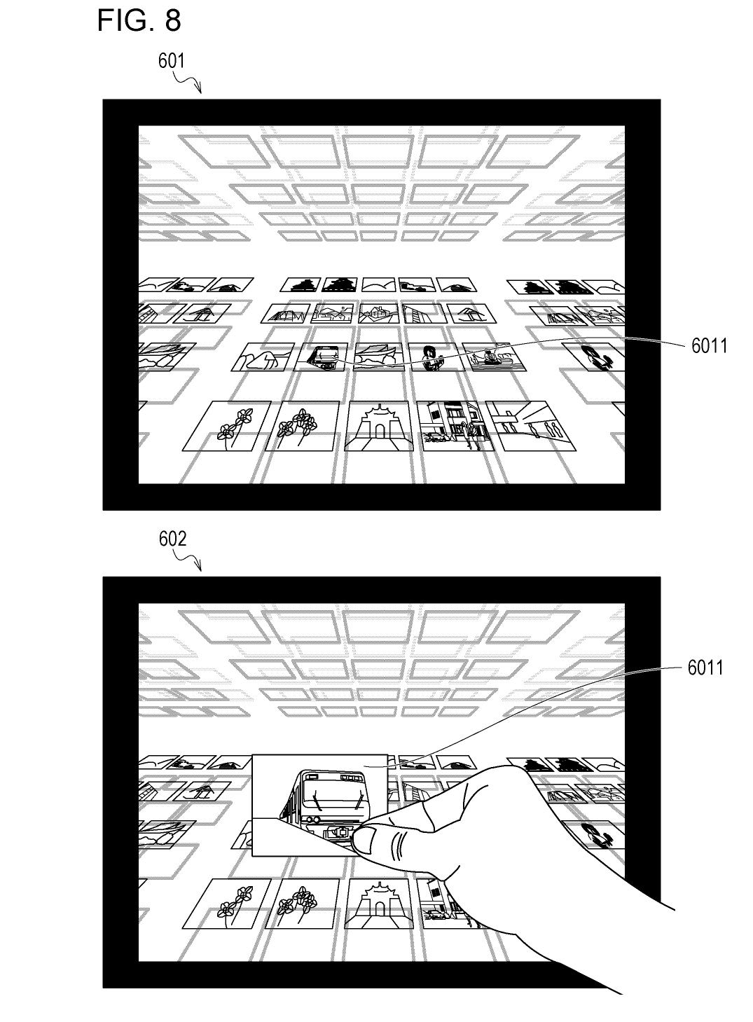

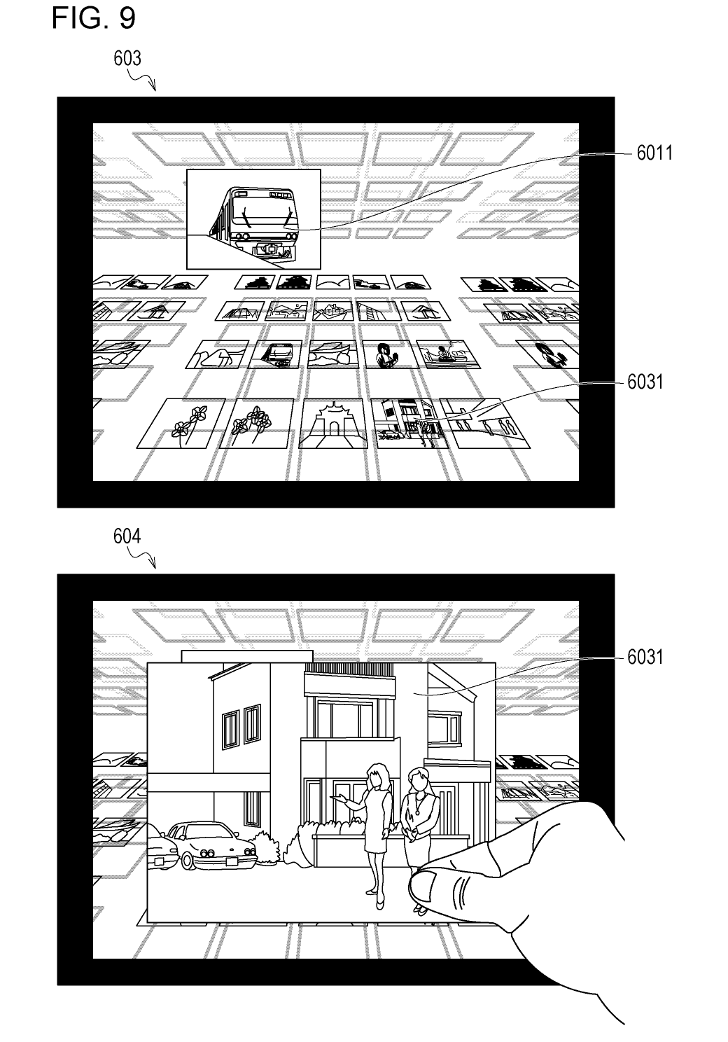

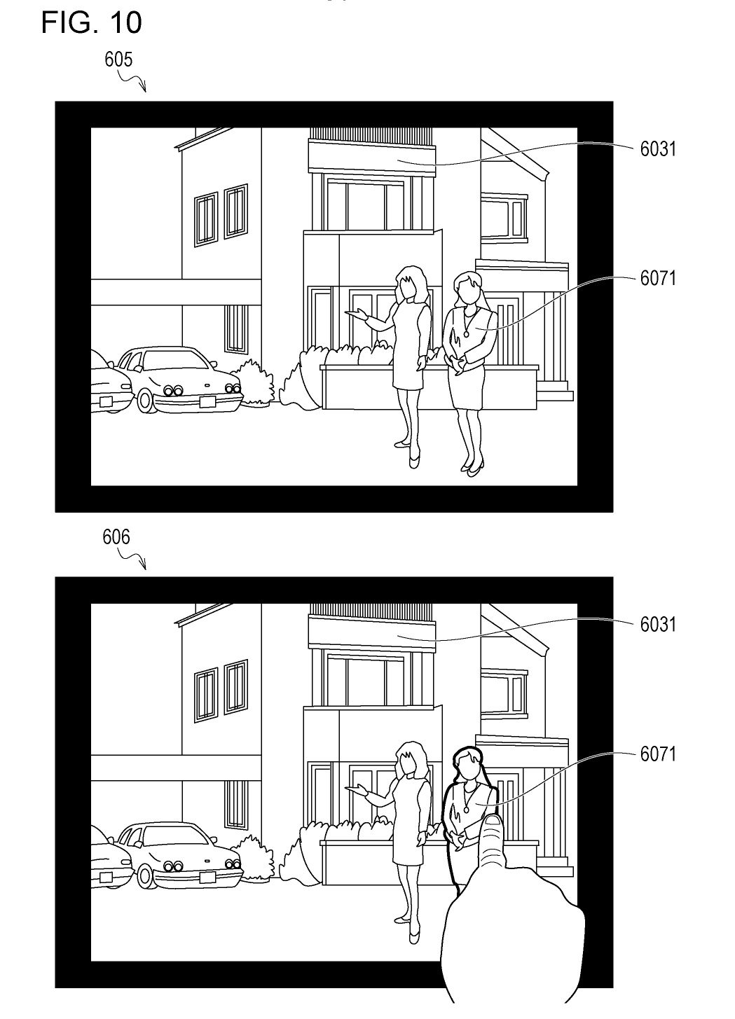

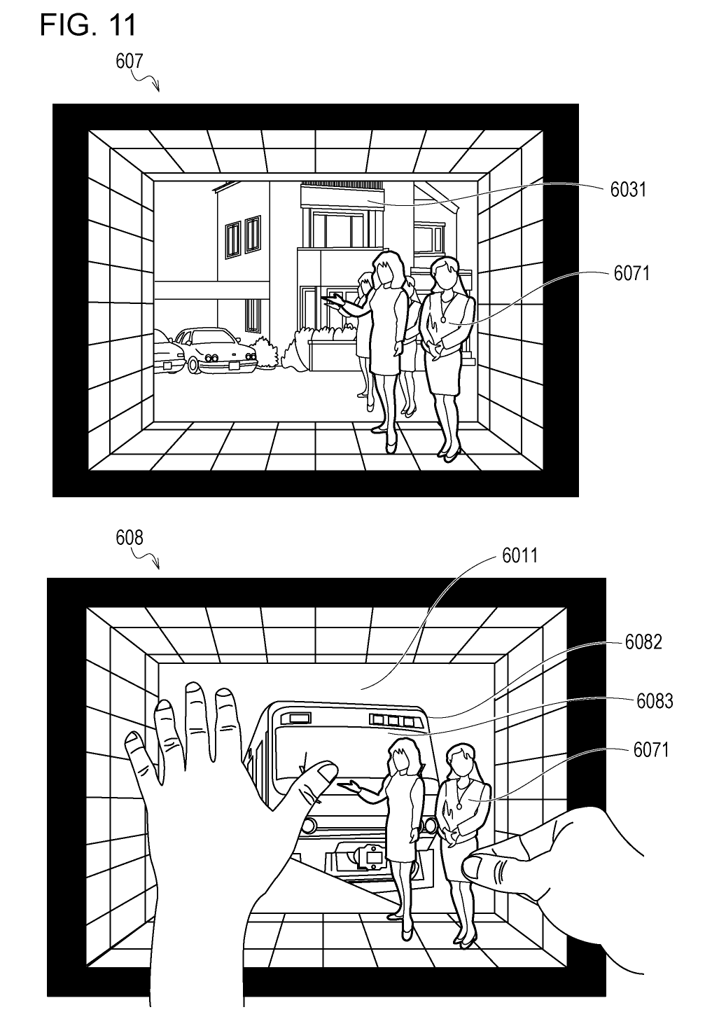

FIGS. 8, 9, 10, and 11 are diagrams illustrating a case where the display control apparatus according to this embodiment is employed in an image editing apparatus. The image editing apparatus generally includes a display screen such as a liquid crystal display, display control means, a storage device such as a hard disk, and calculation means. The image editing apparatus can process and modify images such as photographs by performing trimming, combining, color converting, and the like on the images in response to user's instructions. The image editing apparatus of this embodiment further includes image pickup means, finger distance measurement means, and multi-touch panel means.

A screen 601 represents an initial state of the image editing apparatus (in a state immediately after power is on or the like). Images stored in the image editing apparatus are displayed for the user so as to allow the user to select and specify an image to be edited. A screen 602 represents an image obtained when the user performs pinch-touch on the panel surface. Among a plurality of thumbnails displayed in the screen, a thumbnail 6011 is subjected to the pinch-touch. The thumbnail 6011 is selected as a specific object. When the user's finger moves away from the panel surface (so that the user's finger is pulled toward the user) in a pinch state in which the thumb and at least one of the other fingers are positioned close to each other, the screen 601 changes to the screen 602. In this case, the display of the thumbnail 6011 which is specified by the pinch-touch is changed so that the thumbnail 6011 is located in front of the other objects in the display.

When the user changes a state of the fingers such that the plurality of fingers which have positioned close to each other are moved away from each other, the pinch state is cancelled and the screen 602 is changed to a screen 603. The screen 603 represents a state in which an image corresponding to the thumbnail 6011 is selected as an editing target by the user. When the user performs pinch-touch on a thumbnail 6031 displayed in the screen 603 and the user's fingers move away from the panel surface, the screen 603 is changed to a screen 604. In this case, the display of the thumbnail 6031 which is specified by the pinch-touch is changed so that the thumbnail 6031 is located in front of the other objects.

When the user further moves the user's fingers away from the screen by a predetermined distance or more while the pinch state is maintained, the screen 604 is changed to a screen 605. The screen 605 represents a state in which an image corresponding to the thumbnail 6031 is selected as an editing target by the user. Furthermore, the display is performed as if the user can extract an object from a second object.

As illustrated in a screen 606, the user touches and traces an edge of an object to be extracted from the thumbnail 6031 so as to surround the object to be extracted by a free-form curve. Then, it is determined that the user has instructed an extraction of the object, and the screen 606 is changed to a screen 607. Note that the trace-touch performed on the panel by the finger requires a certain width of a contact surface. However, the object can be extracted by extracting continuous pixels which constitute a contour (edge) of the object so that the contour (boundary) is specified in accordance with comparison and analysis of luminance and hue of pixels included in a region touched by the user's finger.

In the screen 607, an object 6071 which is extracted from the thumbnail 6031 is displayed as an operable object. When the user performs a flicking operation (an operation of tracing a screen while touching the screen) on a region other than the object 6071 in the screen 607, the screen 607 is changed to a screen 608. When the thumbnail 6031 selected as an image to be processed is replaced by the thumbnail 6011.

In the screen 608, the thumbnail 6011 and the object 6071 are displayed in an overlapping manner. In the screen 608, when the user performs pinch-touch on the object 6071 as a specific object, the object 6071 is selected. To the object 6071, the smallest number of display ranking (0, for example) is assigned. Furthermore, the display ranking is assigned to a plurality of regions of the thumbnail 6011 in advance. Here, the display ranking assigned to regions 6082 and 6083 included in the thumbnail 6011 will be described. The region 6082 corresponds to a lead surface of a depicted train and a number 3 of the display ranking is assigned thereto. Furthermore, the region 6083 corresponds to an entire glass window of the depicted train and a number 4 of the display ranking is assigned thereto. Since the object 6071 has the smallest number of the display ranking among the other regions (including the regions 6082 and 6083) in the thumbnail 6011, the object 6071 is displayed in the frontmost position such that the object 6071 overlaps on all regions in the thumbnail 6011. That is, as the number of the display ranking is small, the object corresponding to the number is displayed on a front side.

When the user's finger moves toward the screen in the pinch state, the number of the display ranking assigned to the specific object 6071 becomes large in accordance with the distance between the user's finger and the screen. When the number of the display ranking assigned to the object 6071 exceeds 3 in response to a user's operation, the screen 608 is changed to a screen 609. In the screen 609, a number 3.5 of the display ranking is assigned to the object 6071 in accordance with the distance between the user's finger and the panel surface. Since the number 3.5 of the display ranking is larger than the number 3 of the display ranking assigned to the region 6082, the object 6071 is displayed on a back side relative to the region 6082 such that the region 6082 overlaps on the object 6071. Furthermore, since the number 3.5 of the display ranking is smaller than the number 4 of the display ranking assigned to the region 6083, the object 6071 is displayed on a front side relative to the region 6083.

Furthermore, the user moves the finger in the pinch state in a direction parallel to the screen so that the object 6071 is included in a range in which the region 6082 and the region 6083 overlap with each other in the screen 608. Specifically, when moving the finger in a direction parallel to the screen or in a vertical direction, the user can change the overlapping state of the specific object and the other objects. The object 6071 extracted from the thumbnail 6031 is selected as a specific object. Thereafter, the user can change the overlapping state of the specific object 6071 and the other objects included in the thumbnail 6011 by simply operating the finger in the pinch state.

Note that, as a method for setting display ranking to a plurality of regions displayed on an image, the following method may be employed. It is assumed that an image is captured by an image pickup apparatus including focusing means for performing focusing in accordance with a measurement distance and distances to objects included in the image are recorded. In this case, a method for assigning the first place of display ranking to a range from 0 cm to 30 cm, the second place of the display ranking to a range from 30 cm to 1 m, the third place of the display ranking to a range from 1 m to 3 m, the fourth place of the display ranking to a range from 3 m to 8 m, the fifth place of the display ranking to a range from 8 m to 20 m, and the sixth place of the display ranking to a range from 20 m to ∝ m in accordance with the measurement distances may be employed. Note that the correspondences between the distances and display ranking are merely examples and the correspondences are not limited to these.

Furthermore, the user may arbitrarily set display ranking to a plurality of regions of a target image. Alternatively, as another method, the methods described above may be combined so that the user can change preset display ranking. As described above, various methods may be employed.

The thumbnails (images) of this embodiment are images formed by a group of a large number of fine dots (pixels) which are generally referred to as raster images or bitmap images. Examples of a file format include BMP, JPEG, TIFF, GIF, PNG, and the like. Furthermore, region information and information on the display ranking of the regions may be recorded and managed by a file format used to store metadata attached to image data such as Exif and DCF.

In the first embodiment described above, the apparatus having the display means which performs 2D display has been described as an example. In a second embodiment, a case where 3D display means is employed will be described. In the case of 3D, a “pop-up amount” of a 3D object is changed in accordance with a distance between a body and a panel surface.

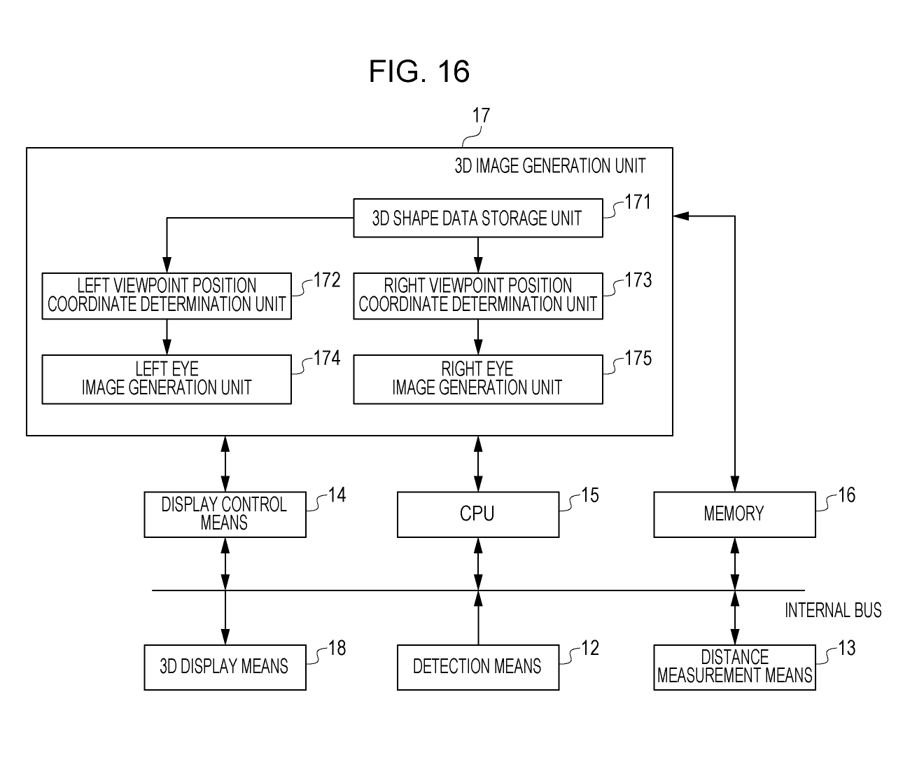

FIG. 16 is a diagram illustrating a configuration of a display control apparatus according to the second embodiment. The display control apparatus of this embodiment includes a 3D image generation unit 17. Furthermore, the 3D image generation unit 17 includes a 3D shape data storage unit 171, a left viewpoint position coordinate determination unit 172, a right viewpoint position coordinate determination unit 173, a left image generation unit 174, and a right image generation unit 175. In general, for 3D images, a “twin-lens 3D image” in which two images having parallax are displayed for right and left eyes of a user has been put into practical use. A computer graphics image is generally obtained by arranging object shape data, a virtual light source, and a virtual camera in a virtual space, and rendering an object viewed from the virtual camera through processes including projection conversion, hidden surface removal, and shading. Furthermore, two virtual cameras having substantially the same optical axis directions are installed with an interval therebetween and rendering is performed from viewpoints of these virtual cameras so as to obtain images for right and left eyes so that a twin-lens 3D image of a computer graphics is obtained. Here, when the object shape data is constituted by flat background shape data which is substantially vertical to the optical axis directions of the two virtual cameras and GUI object shape data and rendering is performed in a state in which the GUI object shape data is disposed in a position popped up toward the virtual cameras from the background shape data, a 3D image having such a visual effect that a GUI object is popped up from the background can be obtained.

Various types of 3D display means 18 are known. The 3D display means 18 may include different display panels for right and left eyes so as to display a parallax image, or may display left and right images which have been subjected to polarization filtering or red-cyan filtering in a single display apparatus in an overlapping manner so that the user sees the images through polarization glasses or red-cyan glasses. Furthermore, the 3D display means 18 may display images for the left and right eyes in a time division manner so that the user sees the images through shutter glasses which open and close in synchronization with the images or may display images corresponding to the left and right eyes using a lenticular sheet having orientation.

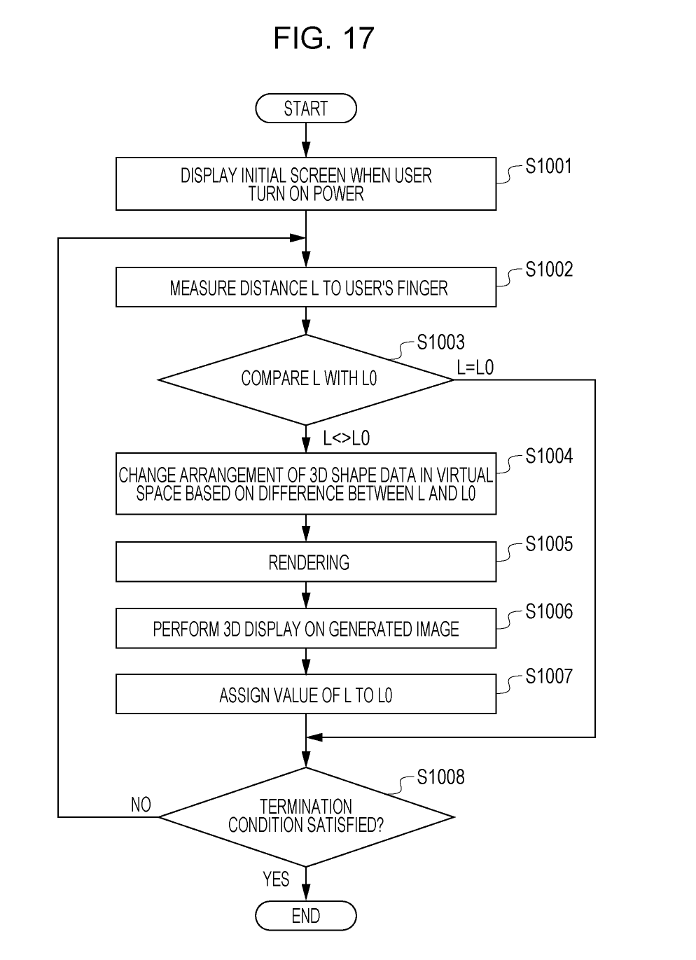

FIG. 17 is a flowchart illustrating a process performed by the display control apparatus according to this embodiment. A pop-up amount of an object displayed in a 3D manner is changed in accordance with a distance between a panel surface of the 3D display means and a user's finger. Note that descriptions of steps the same as those illustrated in the foregoing embodiment are omitted.

In step S1004, when distances L and L0 are different from each other, a position of 3D shape data in the virtual space is changed in accordance with a difference between the distances L and L0. In step S1005, rendering is performed so that a 3D image to be displayed is generated. In step S1006, the 3D display means 18 displays the 3D image in accordance with the generated image.

In this embodiment, the pop-up amount of the 3D object is increased or reduced in accordance with an operation of moving the user's finger away from the panel surface or toward the panel surface. By this, the user can have a visual sensation that the user is “operating” a GUI object.

<Other Embodiments> Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-148284, filed Jul. 4, 2011, which is hereby incorporated by reference herein in its entirety.

What is claimed is:

1. A display control apparatus comprising:
display means capable of displaying a plurality of objects;
detection means for detecting a body;
specifying means for specifying a first object displayed in the display means by a movement of the body;
measurement means for measuring a distance between the body and the display means; and
display control means for determining whether the first object or a second object which is different from the first object is displayed on a front side in the display means in accordance with the distance.

2. The display control apparatus according to claim 1, wherein the display control means displays the first object on the front side when the distance is large.

3. The display control apparatus according to claim 1, wherein the display control means displays the first object on a far side when the distance is small.

4. The display control apparatus according to claim 1, wherein the detection means detects a touch on the display means performed by a user and the specifying means specifies an object touched by the user as the first object.

5. The display control apparatus according to claim 1,
wherein the detection means detects the thumb and at least one of the other fingers of a user which touch the display means in a pinch state in which the thumb and at least one of the other fingers of the user contact each other, and
the measurement means measures a distance between the fingers in the pinch state and the display means.

6. The display control apparatus according to claim 1, wherein the detection means detects a state in which the body stops in the vicinity of a panel for a predetermined period of time or more.

7. The display control apparatus according to claim 1, wherein the display control means changes a display state of the second object in accordance with the distance.

8. The display control apparatus according to claim 7, wherein the display control means changes a blur amount of the second object.

9. The display control apparatus according to claim 1, wherein the display control means changes a display state of the first object.

10. The display control apparatus according to claim 9, wherein the display control means changes a size of the first object.

11. The display control apparatus according to claim 1, wherein the display control means changes a shadow of the first object.

12. The display control apparatus according to claim 1, wherein the display control means displays the first object on an upper layer relative to a layer of the second object.

13. The display control apparatus according to claim 1,
wherein the display means further displays a third object, and
the display control means displays the first object, the second object, and the third object such that an overlapping state of the first object, the second object, and the third object is changeable in accordance with the distance.

14. The display control apparatus according to claim 13, wherein the second object and the third object correspond to different regions included in an image displayed in the display means.

15. The display control apparatus according to claim 14, wherein the first object is extracted from a plurality of objects displayed in an image displayed in the display means.

16. A computer readable storage medium which stores computer programs functioning as the means included in the image processing apparatus according to claim 1.

17. A method for controlling a display apparatus including display means, detection means, specifying means, measurement means, and display control means, the method comprising:
displaying a plurality of objects using the display means;
detecting a body using the detection means;
specifying a first object displayed in the display means by a movement of the body using the specifying means;
measuring a distance between the body and the display means using the measurement means; and
determining whether the first object or a second object which is different from the first object is displayed on a front side in the display means in accordance with the distance using the display control means.
